(19) United States
(12) Patent Application Publication
(10) Pub. No.: US 2026/0204043 A1
(43) Pub. Date: Jul. 16, 2026

(54) CLASS-BALANCED TRAINING FOR SEMI-SUPERVISED SEMANTIC SEGMENTATION WITH LIMITED GROUND TRUTHS USING CONTRASTIVE LEARNING

(71) Applicant: SAP SE, Walldorf (DE)

(72) Inventors: Ankush Mishra, Singapore (SG); Rajesh Vellore Arumugam, Singapore (SG); Anantharaman Ravi, Singapore (SG)

(21) Appl. No.: 19/015,885

(22) Filed: Jan. 10, 2025

(51) Int. Cl. G06V 10/764; G06T 7/11; G06V 10/82

(52) U.S. Cl. CPC G06V 10/764; G06T 7/11; G06V 10/82

(57) ABSTRACT

Methods, systems, and computer-readable storage media for executing semi-supervised training of a network backbone using unlabeled training data, the semi-supervised training including two or more iterations including selecting a batch of unlabeled training data, generating first predictions using a first ML model and second predictions using a second ML model, determining a contrastive loss based on the first predictions and the second predictions, the contrastive loss being determined based on a global normalized confusion matrix (NCM) and a global cluster matrix (CM), adjusting second parameters of the second ML model in response to the contrastive loss, and adjusting first parameters of the first ML model using the second parameters of the second ML model.

### BACKGROUND

Computer vision uses artificial intelligence (AI) to enable computers to identify and understand objects and/or relationships between objects depicted in images (e.g., still images, frames of a video). Computer vision can be implemented in a variety of use cases. Semantic segmentation is used in computer vision, where a machine learning (ML) model processes an image to assign a semantic class label to each pixel in the image. In many use cases, however, training data is sparse, which limits the availability of initial data needed to train and/or fine-tune ML models. Even when large datasets are available, the manual annotation process to label the training data is time- and resource-intensive, creating bottlenecks.

### SUMMARY

Implementations of the present disclosure are directed to a training process for training machine learning (ML) models for visual inspection. More particularly, implementations of the present disclosure are directed to training ML models for visual inspection using semi-supervised training of a student-teacher ML model architecture that incorporates an inter-class pixel affinity module (ICPAM). The ICPAM leverages class semantics and preserves under-represented classes during training using a pixel-level minority-aware contrastive loss (MACL) based on feature similarity and semantic class clustering.

In some implementations, actions include providing a network backbone including a first ML model and a second ML model, executing semi-supervised training of the network backbone using unlabeled training data, the semi-supervised training including two or more iterations including selecting a batch of unlabeled training data, generating first predictions using the first ML model and second predictions using the second ML model, determining a contrastive loss based on at least a portion of the first predictions and at least a portion of the second predictions, the contrastive loss being determined based on a global normalized confusion matrix (NCM) and a global cluster matrix (CM) maintained by an ICPAM that is provided with the network backbone, adjusting second parameters of the second ML model at least partially in response to the contrastive loss, and adjusting first parameters of the first ML model using the second parameters of the second ML model, and after completion of the semi-supervised training, deploying one of the first ML model and the second ML model for inference during production use. Other implementations of this aspect include corresponding systems, apparatus, and computer programs, configured to perform the actions of the methods, encoded on computer storage devices.

These and other implementations can each optionally include one or more of the following features: the first parameters of the first ML model are adjusted using an exponential moving average (EMA) on the second parameters of the second ML model; the global NCM is provided based on batch NCMs and the global CM is provided based on batch CMs across multiple iterations of the semi-supervised training; the contrastive loss is determined using class-bias weights that are determined using the global NCM; the contrastive loss is determined using a first sub-set of the first predictions as positive keys and a second sub-set of the first predictions as negative keys; the contrastive loss is provided as part of a total loss further including a supervised loss, a masking loss, and an adaptation loss; the contrastive loss is determined based on using the at least a portion of the first predictions of the first ML model as ground truths for the at least a portion of the second predictions; prior to execution of the semi-supervised training, the second ML model is trained on a set of labeled training data during a supervised training; and the first ML model is initialized as a copy of the second ML model after the supervised training.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for training of ML models in accordance with implementations of the present disclosure.

FIG. 3 depicts a visualization of inter-class pixel affinity in accordance with implementations of the present disclosure.

FIGS. 4A and 4B collectively depict an algorithm executed by an inter-class pixel affinity module (ICPAM) during semi-supervised training in accordance with implementations of the present disclosure.

FIGS. 5A and 5B collectively depict an algorithm for minority-aware contrastive loss (MACL) during semi-supervised training in accordance with implementations of the present disclosure.

FIG. 6 depicts an example process that can be executed in accordance with implementations of the present disclosure.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are directed to a training process for training machine learning (ML) models for visual inspection. More particularly, implementations of the present disclosure are directed to training ML models for visual inspection using semi-supervised training of a student-teacher ML model architecture that incorporates an inter-class pixel affinity module (ICPAM) that leverages class semantics and preserves under-represented classes during training using a pixel-level minority-aware contrastive loss (MACL) based on feature similarity and semantic class clustering.

Implementations can include actions of providing a network backbone including a first ML model and a second ML model, executing semi-supervised training of the network backbone using unlabeled training data, the semi-supervised training including two or more iterations including selecting a batch of unlabeled training data, generating first predictions using the first ML model and second predictions using the second ML model, determining a contrastive loss based on at least a portion of the first predictions and at least a portion of the second predictions, the contrastive loss being determined based on a global normalized confusion matrix (NCM) and a global cluster matrix (CM) maintained by an ICPAM that is provided with the network backbone, adjusting second parameters of the second ML model at least partially in response to the contrastive loss, and adjusting first parameters of the first ML model using the second parameters of the second ML model, and after completion of the semi-supervised training, deploying one of the first ML model and the second ML model for inference during production use.

To provide further context for implementations of the present disclosure, and as introduced above, computer vision uses artificial intelligence (AI) to enable computers to identify and understand objects and/or relationships between objects depicted in images (e.g., still images, frames of a video). Computer vision can be implemented in a variety of use cases. Example use cases include visual inspection for insulator degradation detection, medical imaging, scene understanding, and manufacturing defect detection, to name a few. With the development of computer vision techniques, automatic visual inspection is enabled through the user of ML models. For example, defect detection models can be trained on visual inspection datasets to identify classes (e.g., types) and locations of defects on products.

Semantic segmentation is used in computer vision, where a ML model processes an image to assign a semantic class label to each pixel in the image. In many use cases, however, training data is sparse, which limits the availability of initial data needed to train and/or fine-tune ML models. Even when large datasets are available, the manual annotation process to label the training data is time- and resource-intensive, creating bottlenecks. One approach to address such issues is unsupervised semantic segmentation. However, this approach faces challenges in accurately extracting pixel-level semantics from unlabeled data, often leading to coarse and imprecise predictions.

To address such issues, semi-supervised segmentation approaches can be considered. In semi-supervised segmentation, a student-teacher framework, which includes a student ML model and a teacher ML model, is used to enhance the learning process. This approach generates pseudo-labels (class label predictions) from the teacher ML model, which the student ML model uses to improve its predictions on unlabeled data. More generally, semi-supervised segmentation uses limited labeled data and abundant unlabeled data to enhance pixel-level labeling accuracy. However, semi-supervised segmentation faces challenges with sparsely annotated images and often suffers from class imbalances. Class imbalances arise when majority classes dominate learning and minority classes remain under-represented.

Accordingly, there is a technical challenge in limited ground truth and class imbalance in training data for semi-supervised semantic segmentation. Further, there is a need to reduce the number of labeled samples required to ensure continual learning and make the training process class-aware to preserve underrepresented classes.

In view of the above context, implementations of the present disclosure provide a MACL for semi-supervised training that is based on pixel-level feature similarity to preserve characteristics of under-represented classes in the labeled dataset. More particularly, and as explained in further detail herein, by leveraging class semantics and penalizing majority class bias, an ICPAM of the present disclosure maximizes the utility of sparsely labeled images, ensuring effective learning from unlabeled data.

In further detail, implementations of the present disclosure provide semi-supervised training of a student-teacher ML model architecture that incorporates an ICPAM. In some implementations, the ICPAM is configured to leverage class semantics and preserve under-represented classes during training. The ICPAM introduces a pixel-level MACL based on feature similarity and semantic class clustering. More particularly, the ICPAM mitigates class bias by penalizing majority classes through class-bias weights derived from a normalized confusion matrix (NCM). This focal loss mechanism maximizes the utility of sparsely labeled images and ensures class balance throughout training on unlabeled datasets.

With regard to class-aware training using semi-supervised semantic segmentation with limited ground truth, a training dataset denoted as (X, Y) can be considered, where X represents training images and Y corresponds to pixel-level segmentation labels. In the context of semi-supervised semantic segmentation, these labels can either come from human-labeled data during supervised training or be generated as pseudo-labels from the unlabeled data during semi-supervised training. However, with a limited labeled dataset, the ML model often struggles with generalizing to the unlabeled data. This is due to class imbalance and a domain gap between the labeled and unlabeled partitions.

To tackle these challenges, the ICPAM of the present disclosure integrates multiple strategies. For example, the contrastive pixel-level loss, MACL, is provided, which is based on feature correspondences, leveraging feature similarity by maintaining class-specific features through online clustering in a cluster matrix (CM). To effectively mitigate class imbalance, a global NCM is maintained, which steers the attention of the ML model toward minority classes during training.

Implementations of the present disclosure are described in further detail herein with reference to an example use case for visual inspection. The example use case includes visual inspection of insulators on powerlines for degradation. It is contemplated, however, that implementations of the present disclosure can be realized for any appropriate use case.

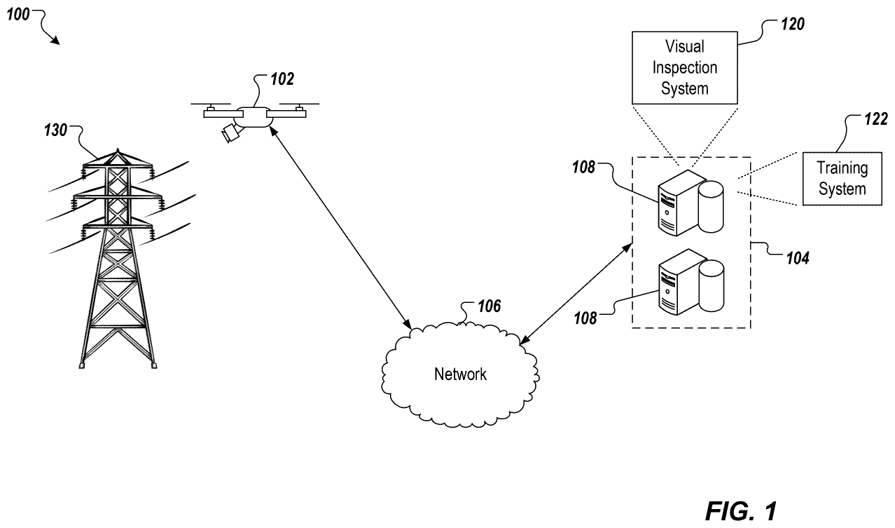

FIG. 1 depicts an example system 100 that can execute implementations of the present disclosure. The example system 100 includes a drone 102, a back-end system 104, and a network 106. In some examples, the network 106 includes a local area network (LAN), wide area network (WAN), the Internet, or a combination thereof, and connects web sites, devices (e.g., the drone 102), and back-end systems (e.g., the back-end system 104). In some examples, the network 106 can be accessed over a wired and/or a wireless communications link.

In some examples, the drone 102 can include a camera for capturing images (e.g., still images, video) and communication components that enable the drone 102 to communicate with the network 106 and the back-end system 104.

In the depicted example, the back-end system 104 includes at least one server system 108 (e.g., with a data store). In some examples, the at least one server system 108 hosts one or more computer-implemented services that users can interact with using computing devices. For example, the server system 108 can host a visual inspection system 120 in accordance with implementations of the present disclosure.

In the example of FIG. 1, a powerline tower 130 is depicted, to which powerlines are secured using insulators. In the context of the present disclosure, the camera of the drone 102 can generate images as digital data representing the insulators of the powerline tower 130. In accordance with implementations, images can be processed by the visual inspection system 120 to determine whether the insulators, as represented within the image(s), includes any degradation. For example, the visual inspection system 120 can process images through a ML model that assigns class labels to pixels of the images, the class labels indicating presence (or absence) of degradation.

In accordance with implementations of the present disclosure, the ML model of the visual inspection system 120 is trained by a training system 122 that is hosted in the back-end system 104. More particularly, and as described in further detail herein, the ML model is trained using semi-supervised training of a student-teacher ML model architecture that incorporates an ICPAM. As discussed herein, the ICPAM leverages class semantics and preserves under-represented classes during training using a pixel-level MACL based on feature similarity and semantic class clustering.

In general, a student-teacher ML model architecture can be described as a ML framework where a more complex teacher ML model transfers knowledge to a simpler student ML model, often using techniques such as knowledge distillation. The student learns to mimic the teacher's predictions or representations. Examples include a large convolution neural network (CNN) or Transformer model (teacher) guiding a smaller neural network (student), pretrained models like BERT (teacher) in the text domain distilling knowledge into smaller versions like DistilBERT (student), or an ensemble of models (teacher) teaching a single model (student) to approximate its outputs. However, and as described in further detail herein, implementations of the present disclosure include a teacher ML model and a student ML model that are both transformer neural networks with the exact same architecture.

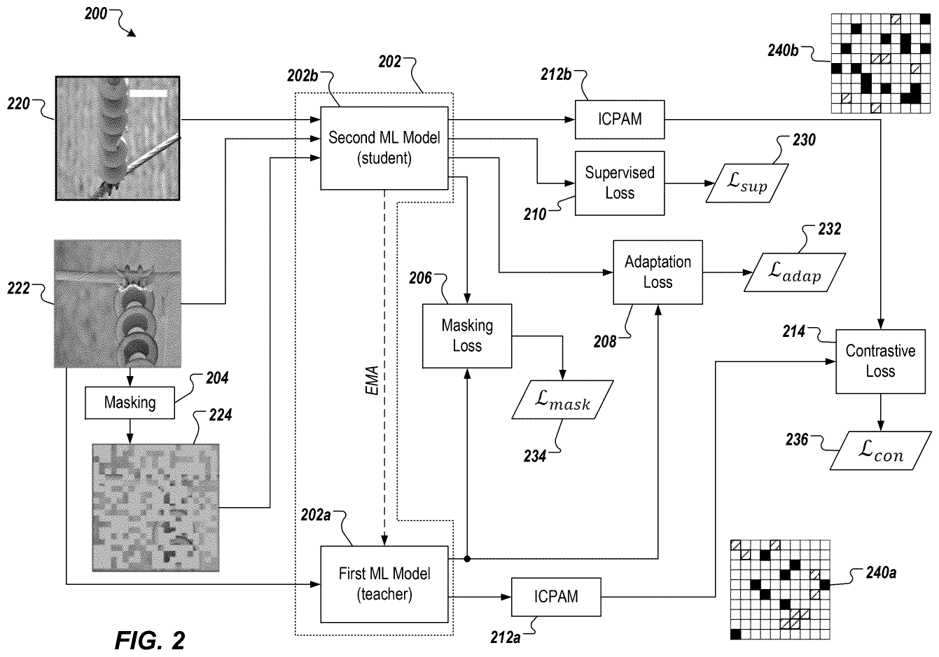

FIG. 2 depicts an example conceptual architecture 200 for training of ML models in accordance with implementations of the present disclosure. As described in further detail herein, the example of FIG. 2 represents the supervised phase and the semi-supervised phase of the training. In the depicted example, the conceptual architecture 200 includes a network backbone 202 that includes a first ML model 202a (teacher ML model) and a second ML model 202b (student ML model). In the depicted example, the conceptual architecture 200 also includes a masking module 204, a masking loss module 206, an adaptation loss module 208, a supervised loss module 210, and a contrastive loss module 214.

In accordance with implementations of the present disclosure, an ICPAM is included, which is collectively represented as an ICPAM 212a and an ICPAM 212b (collectively referred to as an ICPAM 212). In some implementations, the ICPAM 212 is configured to provide a contrastive loss that guides training toward minority classes during semi-supervised training, especially when dealing with limited labeled data. As described in further detail herein, the ICPAM 212 includes a NCM and a projection head that maintains a CM.

In further detail, the network backbone 202 is trained with a supervised loss 230 on labeled images 220, an unsupervised adaptation loss 232 on unlabeled images 222, and a masking loss 234 computed between predictions on masked target images 224 and pseudo-labels generated by the first ML model 202a, and a MACL 236. In some implementations, the MACL (contrastive loss) 236 penalizes misclassification of minority classes and encourages pixels with low-confidence predictions (shown in darker shaded squares of outputs 240a, 240b) to move toward the positive key in the feature space, which is formed using high-confidence pixels (depicted in lighter shaded squares of the ICPAM outputs 240a, 240b). The approach utilizes pixel affinity using the ICPAM 212 to preserve class-specific features throughout training. The final output during inference is a segmentation mask highlighting, in the example use case, regions of an image that depict insulators (e.g., porcelain shells).

In the context of the example use case, the training data can be provided as the open-source EPRI Insulator Defect Dataset V1.2, which closely resembles real-world datasets and lacks segmentation labels. The task involves segmenting porcelain insulator shells from the transmission line in the image and the segmented regions are processed to detect defects (e.g., degradation). The process segments the image into a binary mask, with the shells as the foreground and the remaining structure, including the conductor holding the shells, as the background. The standard semi-supervised training flow is followed as described in further detail herein. In the training data, 5% of the images are densely annotated (e.g., each pixel is assigned a class label) for the semantic segmentation task, and the goal is to generalize the performance of the ML model to the remaining 95% of the training data, which is unlabeled.

In the network backbone 202, the second ML model 202b, which can also be referred to as a base segmentation model and/or the student ML model, is trained on the labeled images (e.g., the images 220) in a supervised manner. In general, supervised training can be described as an iterative training process, where, during an iteration (also referred to as epoch), one or more parameters of the ML model are adjusted, and an output is generated based on the training data (e.g., segment mask predictions). For each iteration, a loss value (e.g., supervised loss ( [symbol] ₛᵤₚ) 230) is determined based on a loss function (e.g., by the supervised loss module 210). The loss value represents a degree of accuracy of the output of the ML model. The loss value can be described as a representation of a degree of difference between the output of the ML model and an expected output of the ML model (e.g., the segment mask annotations provided in the training data). In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value. After the supervised training, the first ML model 202a, also referred to as the teacher ML model, is initialized as a copy of the (trained) second ML model 202b.

In some examples, the masking module 204 randomly masks 40-70% of the regions in the original input image using pre-defined standard-sized patches. As described in further detail herein, the masked image is fed to the student ML model, while the unmasked original image is provided to the teacher ML model. Because the teacher ML model receives the complete image, it is able to make reliable predictions. These predictions from the teacher ML model serve as pseudo-labels for the masked image given to the student ML model. The loss is calculated by comparing the student ML model's predictions on the masked image with the pseudo-labels (ground truth) using cross-entropy. By encouraging consistency between the predictions of the student ML model on the masked and unmasked regions, the loss helps the student ML model better capture contextual information and improve its overall understanding of the image.

With regard to semi-supervised training on unlabeled data, in some examples, unlabeled images (e.g., the unlabeled images 222) are fetched into the network backbone 202 in batches and are processed by the first ML model 202a and the second ML model 202b, with their respective outputs being processed by the ICPAM 212. It can be seen that, a domain gap becomes apparent between the labeled and unlabeled images of the EPRI dataset, revealing differences in shell shape, color, orientation, and background.

As the semi-supervised training progresses through iterations (epochs), the weights of the first ML model 202a, along with a respective projection head in the ICPAM 212, are updated using an exponential moving average (EMA) of the weights of the second ML model 202b. That is, while weights of the second ML model 202b are adjusted across iterations using back-propagation of gradients based on loss (e.g., a total loss, described in further detail herein), gradients are not propagated back to the first ML model 202a. Instead, the weights (parameters) of the first ML model 202a are updated using EMA of the weights (parameters) of the second ML model 202b during the update process.

At a high-level, EMA can be described as a type of moving average (MA) that places a greater weight and significance on the most recent data points. In further detail, EMA is used to update the teacher ML model by gradually incorporating the values of parameters of the student ML model parameters. Instead of directly copying the values after each training step, the values of the teacher ML model are updated to be a weighted average of the current values of the teacher ML model and the values of the student ML model. This means that the values of the teacher ML model change slowly over time, giving more weight to its previous state and gradually adapting to the updates to the student ML model. Using EMA is to ensures that the teacher ML model evolves more smoothly, providing more stable and consistent predictions. By doing so, EMA helps the teacher ML model avoid drastic changes that could result from noisy or unstable updates from the student ML model. This gradual update mechanism allows the teacher ML model to maintain reliable performance, even as the student ML model learns and adapts during training.

In accordance with implementations of the present disclosure, the ICPAM 212 is updated during training. More particularly, at the end of each batch of unlabeled images 222, a global NCM and a global CM (e.g., NCM and CM provided across all batches) are updated with a batch NCM and a batch CM (e.g., NCM and CM provided for a respective batch) using EMA. Class-bias weights are derived from the global NCM Text use to guide a contrastive loss, enhancing sensitivity to minority classes while mitigating the influence of majority classes (hard negatives).

With regard to loss functions, in addition to standard losses (e.g., the adaptation loss ( [symbol] _{adap}) 232, which emphasizes consistency between strong and weak augmentations of an image; the masking loss ( [symbol] ₘₐₛₖ) 234, which ensures consistency between the outputs of masked and unmasked images), the pixel-level contrastive loss ( [symbol] _{con}) 236, also referred to as MACL, is determined. As described herein, the contrastive loss 236 incorporates the class-bias weights that maintain class-misclassification characteristics and preserve minority classes.

In some examples, the adaptation loss ( [symbol] _{adap}) is determined during semi-supervised training by processing original, unaltered images by the first ML model 202a and processing augmented versions of the same images by the second ML model 202b. This creates a more challenging task for the second ML model 202b as compared to the first ML model 202a, and the adaptation loss ( [symbol] _{adap}) is computed as the cross-entropy loss between the predictions. Because both predictions are based on the same underlying images, they must remain consistent, helping to improve the generalization ability of the second ML model 202b over iterations of the semi-supervised training. In some examples, the masking loss ( [symbol] ₘₐₛₖ) is determined during the semi-supervised training based on differences between the predictions of the second ML model 202b on the masked images as compared to the predictions of the first ML model 202a on the unmasked images. In some examples, the supervised loss ( [symbol] ₛᵤₚ) is used during supervised training of the second ML model 202b using cross-entropy between predictions of the second ML model 202b and the corresponding ground truth (provided in the labeled training data).

As the semi-supervised training progresses, the weights of both the first ML model 202a and the second ML model 202b converge. The ICPAM 212 is only active during training to guide the segmenter through the contrastive loss. After training has concluded, the ICPAM 212 is discarded for inference.

Here, a segmenter refers to any ML model that performs segmentation tasks. In this context, the term segmenter is used to refer to both the second ML model 202b and the first ML model 202a. During inference, the architecture generates a segmentation mask for an unlabeled image (i.e., an image not used in training, such as an image generated by the drone 102 of FIG. 1). The segmentation mask highlights the shell regions (e.g., in red as the foreground), while displaying the remaining parts of the image (e.g., in black) as the background. For inference, the architecture includes the first ML model 202a (the teacher ML model) that was trained during the semi-supervised training, as described herein. Images are then fed to this model, and its predictions are recorded.

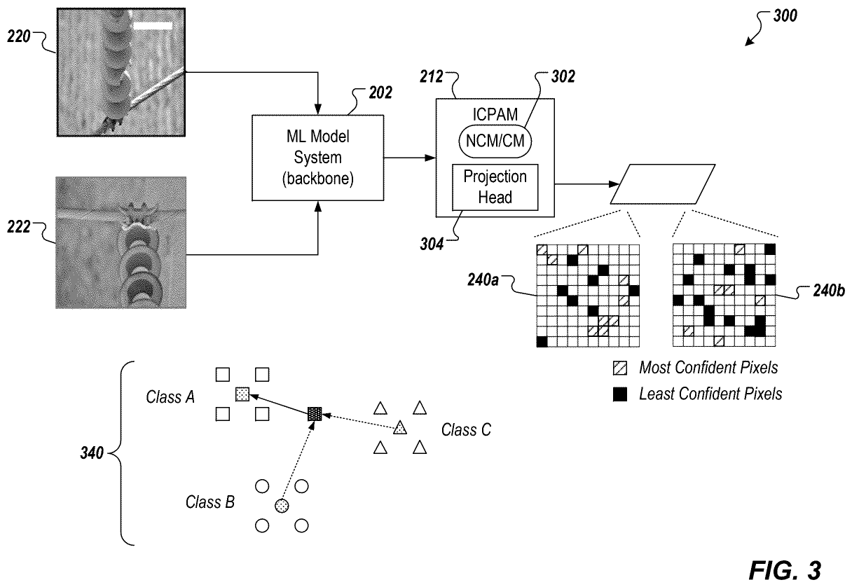

FIG. 3 depicts a visualization 300 of inter-class pixel affinity in accordance with implementations of the present disclosure. The visualization 300 of FIG. 3 depicts the network backbone 202, the ICPAM 212, the labeled images 220 (for supervised training of the second ML model 202b) and the unlabeled images 222 (for unsupervised training of the first ML model 202a and the second ML model 202b). As described herein, the ICPAM 212 maintains a global NCM and a global CM 302 during training based on batch NCMs and batch CMs, respectively. As also described herein, the ICPAM 212 includes a projection head that provides projections as outputs 240a, 240b for the first ML model 202a and the second ML model 202b, respectively, for each iteration of training.

In further detail, during iterations of the semi-supervised training, the NCM is used to construct a CM using the prediction provided by the second ML model 202b and prediction provided by the first ML model 202a, which is treated as a ground truth. The projection head 304 maps outputs to a higher-dimensional space, preserving image dimensions. More particularly, the ICPAM 212 captures class relationships through k-means clustering, forming class-wise clusters from high-confidence pixels. For low-confidence pixels (queries), similarity is enforced with the center of the nearest class cluster (positive key), while dissimilarity is emphasized based on their distance from other class centers (negative keys). By way of non-limiting example, this is represented as a cluster map 340 in FIG. 3.

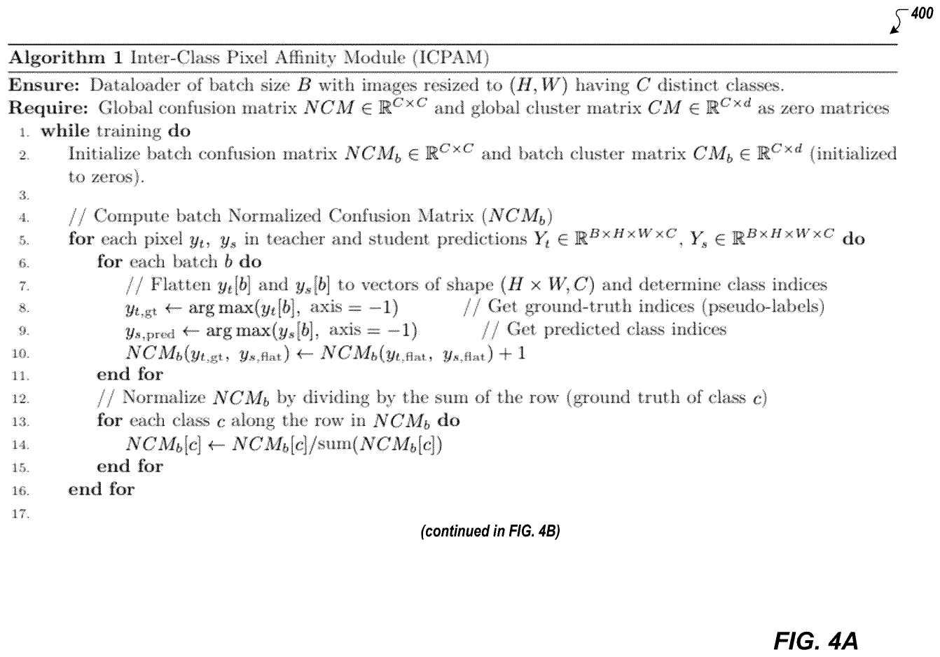

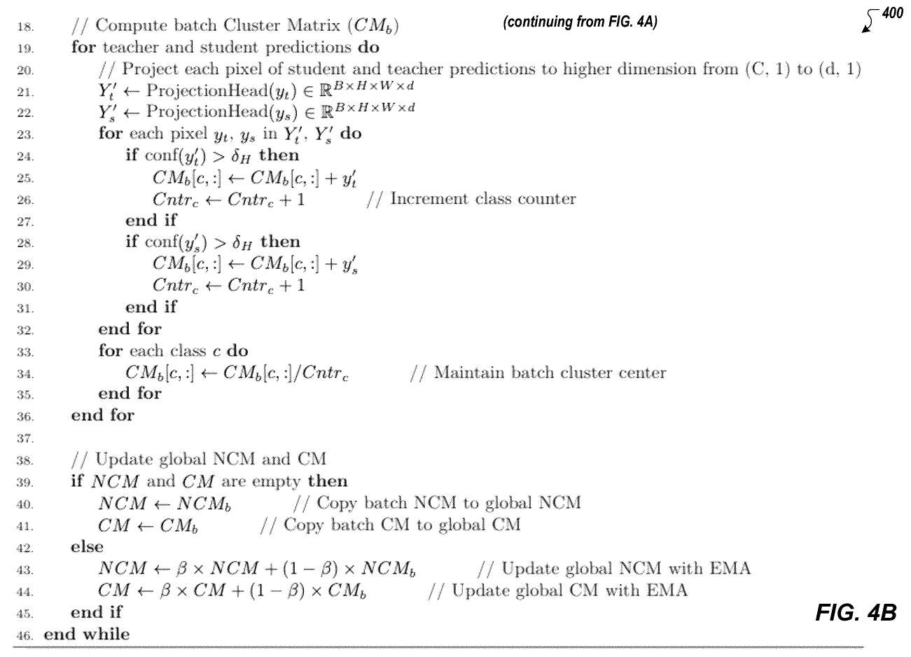

FIGS. 4A and 4B collectively depict an algorithm 400 (Algorithm 1) executed by the ICPAM during semi-supervised training in accordance with implementations of the present disclosure. As described herein, and as represented in the algorithm 400 of FIGS. 4A and 4B, a batch NCM is computed for each batch of unlabeled images processed during semi-supervised training. The global NCM is determined using the outputs of the student ML model (e.g., the second ML model 202b of FIG. 2) as the predictions and the outputs (pseudo-labels) of the teacher ML model (e.g., the first ML model 202a of FIG. 2) as ground truths. In some examples, the global NCM is normalized against the ground truths to allow for accurate bias estimation, particularly focusing on misclassifications of minority classes as dominant majority classes. Class-bias scores are constructed for addressing the disproportionate errors made with minority classes.

As described herein, the projection head (e.g., the projection head 304 of FIG. 3) transforms the outputs of the student ML model and the outputs of the teacher ML model into a higher-dimensional space, while preserving spatial resolution. The CM is derived from class centroids, based on the projected outputs of high-confidence pixels (e.g., as represented in the cluster map 340 of FIG. 3). Both the NCM and CM are updated using EMA after each batch. In this manner, a dynamic (during training) global representation of class biases is provided and the treatment of under-represented classes is improved during training. As noted herein, the ICPAM operates solely during training, guiding the segmenter through contrastive loss (MACL), and is omitted during inference.

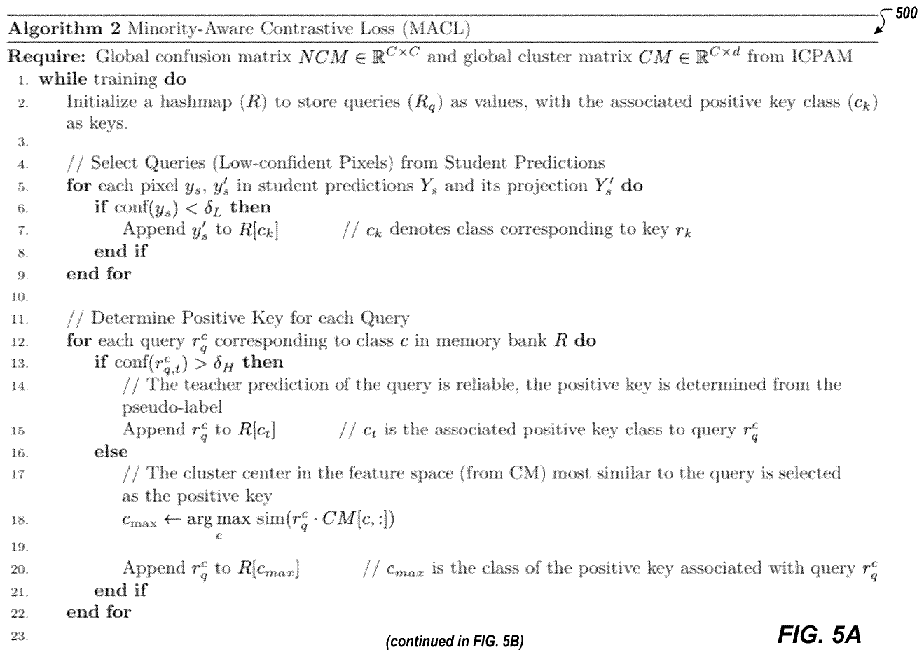

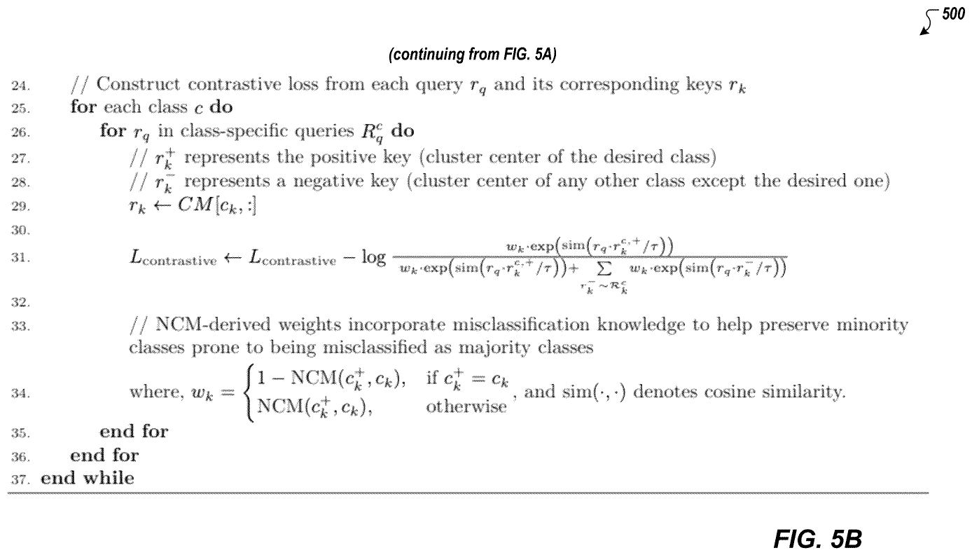

FIGS. 5A and 5B collectively depict an algorithm 500 (Algorithm 2) for determining MACL during semi-supervised training in accordance with implementations of the present disclosure. As described herein, the MACL of the present disclosure targets difficult queries with low pixel confidence weighted with class-bias scores to ensure the preservation of minority class features, particularly in settings where labeled data is sparse. Contrastive learning operates by identifying query-key pairs to enforce similarity and dissimilarity. In MACL, the queries are low-confidence pixels—those with prediction confidence below a defined threshold—that need further training guidance. Keys are the class centroids of high-confidence pixels, derived from both the predictions (output) of the student ML model and the predictions (output) of the teacher ML model.

For each batch, a cluster map (e.g., the cluster map 340 of FIG. 3) is generated FROM THE HIGH-CONFIDENCE PIXELS. THE POSITIVE KEY FOR A QUERY (RQ) IS DETERMINED FROM THE class (c∈C) closest to the query if the prediction of the teacher ML model of the same pixel is unreliable. In some examples, a pixel is deemed to be unreliable if a confidence score for the pixel (provided with the prediction of the first ML model 202a) is below a predefined threshold. Otherwise, the prediction of the teacher ML model is selected as the positive key

$$( {r}_{k}^{c , +} ) .$$

All other class centers serve as negative keys

$$( {r}_{k}^{-} )$$

wherein hard negatives are determined by their proximity to the query, addressing frequent misclassifications due to spatial or semantic similarities. Unlike traditional methods, this approach integrates predictions of the teacher ML model when reliable, providing precise guidance on uncertain pixels.

To reduce the dominance of majority classes, class-bias weights (wₖ) are derived from the global NCM, as outlined in the algorithm 500. These weights protect minority classes by penalizing misclassifications into dominant classes. The loss encourages low-confidence pixels to align with their positive key and remain dissimilar from negative keys through cosine similarity, sim(·,·), modulated by a temperature parameter r to control the softness of the distribution. It also emphasizes reducing misclassification of minority classes. The overall expression for the contrastive loss, L_{con} (or L_{contrastive}), can be provided as:

$${L}_{constrastive} = {\sum }_{c ∈ 𝒞} {\sum }_{{r}_{q} ∼ {ℛ}_{q}^{c}} - log \frac{{w}_{k} \cdot exp ( sim ( {r}_{q} \cdot {r}_{k}^{c , +} / τ ) )}{{w}_{k} \cdot exp ( sim ( {r}_{q} \cdot {r}_{k}^{c , +} / τ ) ) + {\sum }_{{r}_{k}^{-} ∼ {ℛ}_{k}^{c}} {w}_{k} \cdot exp ( sim ( {r}_{q} \cdot {r}_{k}^{-} / τ ) )}$$

$$where , {w}_{k} = \{ \begin{matrix}1 - NCM ( {c}_{k}^{+} , {c}_{k} ) , & if {c}_{k}^{+} = {c}_{k} \\ NCM ( {c}_{k}^{+} , {c}_{k} ) , & otherwise\end{matrix}$$

The IPCAM of the present disclosure integrates seamlessly with any student-teacher-based network, requiring no modifications to the training process and adding no extra cost during inference. To incorporate MACL, the ICPAM is incorporated with the network backbone and the active key-query sampling strategy is employed, as described herein. In the semi-supervised training phase, where ground-truth annotations are limited, the MACL is integrated into the training loss. Instead of relying solely on the initial segmentation network (the student ML model), its copy, the teacher ML model, is created at the start of the semi-supervised training. As described herein, the teacher model generates pseudo-labels from unlabeled images, providing guidance to the predictions of the student ML model. The teacher ML model operates as an EMA teacher, introducing a temporal ensemble effect that enhances pseudo-label stability.

Through the semi-supervised training, the student ML model is trained using augmented and masked unlabeled images, supervised by the pseudo-labels of the teacher ML model. The teacher ML model, with access to the original images, enhances pseudo-label quality by retaining both contextual information and fine local details. The MACL of the present disclosure leverages dynamic class relationships and mitigates class bias. The overall training loss for semi-supervised segmentation can be provided as:

$${ℒ}_{total} = {ℒ}_{sup} + {η}_{1} \cdot {ℒ}_{adap} + {η}_{2} \cdot {ℒ}_{mask} + {η}_{3} \cdot {ℒ}_{con}$$

where η₁, η₂, and η₃ are weights. During training, the total loss is minimized by adjusting parameters of the student ML model across iterations and using EMA to adjust parameters of the teacher ML model across iterations. After training, during inference, segmented regions from all identified shells and background mask are produced as the final output of the architecture.

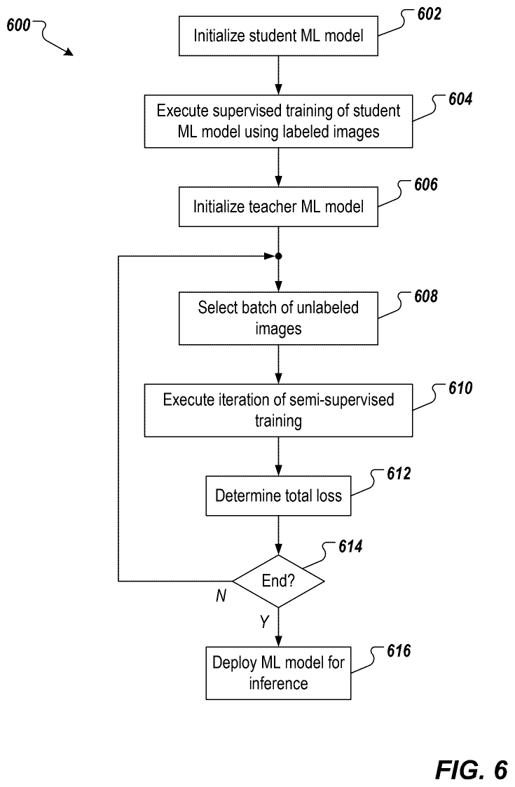

FIG. 6 depicts an example process 600 that can be executed in accordance with implementations of the present disclosure. In some examples, the example process 600 is provided using one or more computer-executable programs executed by one or more computing devices.

A student ML model is initialized (602) and supervised training of the student ML model is executed (604). For example, and as described herein, the second ML model 202b of FIG. 2 can be initialized with initial parameter values. Supervised training is executed using labeled images 220. In some examples, supervised training of the second ML model 202b is executed until a supervised loss is minimized. A teacher ML model is initialized (606). For example, and as described herein, the first ML model 202a, also referred to as the teacher ML model, is initialized as a copy of the (trained) second ML model 202b.

A network backbone is provided with a student ML model and a teacher ML model and semi-supervised training of the network backbone is executed. For example, a batch of unlabeled images is selected (608) and an iteration of semi-supervised training is executed (610). For example, and as described herein, the second ML model 202b processes unlabeled images to provide predictions (e.g., pixel-level class labels) and the first ML model 202a processes unlabeled images to provide predictions (e.g., pixel-level class labels). The predictions of the first ML model 202a can be used as ground truths for evaluating the predictions of the second ML model 202b.

A total loss is determined (612) and it is determined whether the semi-supervised training is to end (614). For example, and as described herein, a total loss ( [symbol] ₜₒₜₐₗ) is determined based on the contrastive loss ( [symbol] ₜₒₜₐₗ; MACL) of the present disclosure, which is determined by the ICPAM of the present disclosure. In some examples, if the total loss is determined to be minimized (or a pre-defined number of iterations of semi-supervised training have been executed), the semi-supervised training can end. Otherwise, the semi-supervised training continues. If the semi-supervised training is not to end, the example process 600 loops back to perform another iteration using another batch of unlabeled images. If the semi-supervised training is ended, the ML model is deployed for inference (616).

Implementations of the present disclosure provide multiple technical advantages. For example, the NCM component addresses class imbalance in semi-supervised segmentation by approximating inherent class bias in predictions. More particularly, the NCM can be used to identify which minority classes are being misclassified as dominant majority classes, providing insights for constructing class-bias scores. The projection head with the CM component maintains an online cluster map that guides the network when labels are absent or pseudo-labels are unreliable. This cluster preserves class semantics from supervised training and offers robust guidance to the network throughout semi-supervised training. Further, the contrastive loss, MACL, of the present disclosure focuses on low-confidence pixels frequently subject to misclassification. By applying a distance-guided penalty from query to centroid, the MACL is used to penalize hard negative keys based on feature similarity, offering guidance in the absence of reliable supervision. The emphasis on class-bias weights mitigates misclassification of minority and under-represented classes during training. Overall, introduction of the ICPAM reduces the minimum number of labeled samples needed for the ML model to generalize to the unlabeled partition. By incorporating MACL, this threshold can be lowered, enabling continual learning on unlabeled data and significantly reducing the burden of dense annotation for semantic segmentation. The architecture, featuring a base student-teacher network and an auxiliary ICPAM, integrates seamlessly with any semantic segmentation architecture.

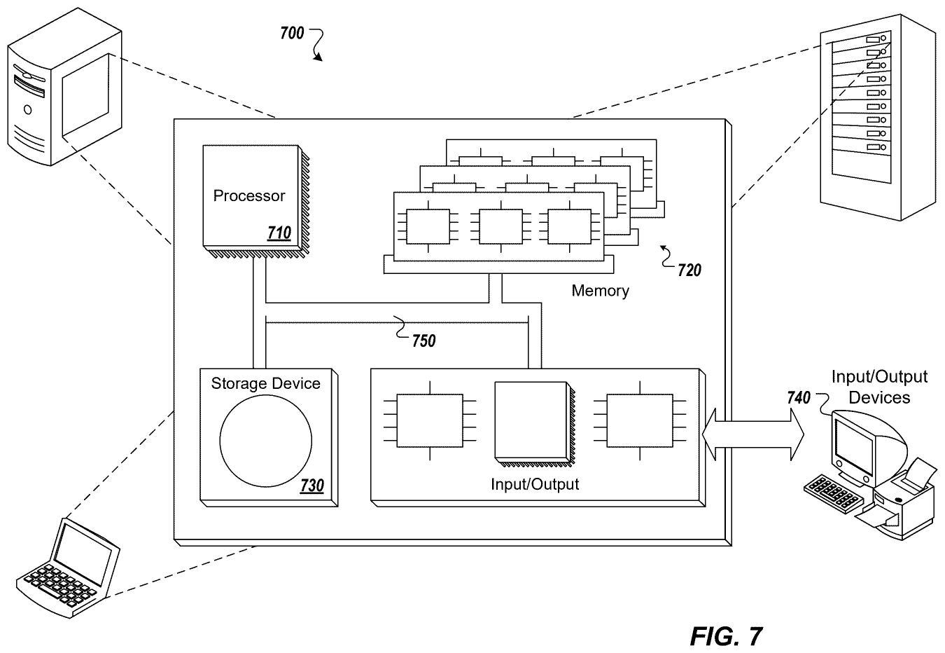

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for provisioning machine learning (ML) models for visual inspection, the method being executed by one or more processors and comprising:
providing a network backbone comprising a first ML model and a second ML model;
executing semi-supervised training of the network backbone using unlabeled training data, the semi-supervised training comprising two or more iterations comprising:
selecting a batch of unlabeled training data,
generating first predictions using the first ML model and second predictions using the second ML model,
determining a contrastive loss based on at least a portion of the first predictions and at least a portion of the second predictions, the contrastive loss being determined based on a global normalized confusion matrix (NCM) and a global cluster matrix (CM) maintained by an inter-class pixel affinity module (ICPAM) that is provided with the network backbone,
adjusting second parameters of the second ML model at least partially in response to the contrastive loss, and
adjusting first parameters of the first ML model using the second parameters of the second ML model; and
after completion of the semi-supervised training, deploying one of the first ML model and the second ML model for inference during production use.

2. The method of claim 1, wherein the first parameters of the first ML model are adjusted using an exponential moving average (EMA) on the second parameters of the second ML model.

3. The method of claim 1, wherein the global NCM is provided based on batch NCMs and the global CM is provided based on batch CMs across multiple iterations of the semi-supervised training.

4. The method of claim 1, wherein the contrastive loss is determined using class-bias weights that are determined using the global NCM.

5. The method of claim 1, wherein the contrastive loss is determined using a first sub-set of the first predictions as positive keys and a second sub-set of the first predictions as negative keys.

6. The method of claim 1, wherein the contrastive loss is provided as part of a total loss further comprising a supervised loss, a masking loss, and an adaptation loss.

7. The method of claim 1, wherein the contrastive loss is determined based on using the at least a portion of the first predictions of the first ML model as ground truths for the at least a portion of the second predictions.

8. The method of claim 1, wherein, prior to execution of the semi-supervised training, the second ML model is trained on a set of labeled training data during a supervised training.

9. The method of claim 8, wherein the first ML model is initialized as a copy of the second ML model after the supervised training.

10. A non-transitory computer-readable storage medium coupled to one or more processors and having instructions stored thereon which, when executed by the one or more processors, cause the one or more processors to perform operations for provisioning machine learning (ML) models for visual inspection, the operations comprising:
providing a network backbone comprising a first ML model and a second ML model;
executing semi-supervised training of the network backbone using unlabeled training data, the semi-supervised training comprising two or more iterations comprising:
selecting a batch of unlabeled training data,
generating first predictions using the first ML model and second predictions using the second ML model,
determining a contrastive loss based on at least a portion of the first predictions and at least a portion of the second predictions, the contrastive loss being determined based on a global normalized confusion matrix (NCM) and a global cluster matrix (CM) maintained by an inter-class pixel affinity module (ICPAM) that is provided with the network backbone,
adjusting second parameters of the second ML model at least partially in response to the contrastive loss, and
adjusting first parameters of the first ML model using the second parameters of the second ML model; and
after completion of the semi-supervised training, deploying one of the first ML model and the second ML model for inference during production use.

11. The non-transitory computer-readable storage medium of claim 10, wherein the first parameters of the first ML model are adjusted using an exponential moving average (EMA) on the second parameters of the second ML model.

12. The non-transitory computer-readable storage medium of claim 10, wherein the global NCM is provided based on batch NCMs and the global CM is provided based on batch CMs across multiple iterations of the semi-supervised training.

13. The non-transitory computer-readable storage medium of claim 10, wherein the contrastive loss is determined using class-bias weights that are determined using the global NCM.

14. The non-transitory computer-readable storage medium of claim 10, wherein the contrastive loss is determined using a first sub-set of the first predictions as positive keys and a second sub-set of the first predictions as negative keys.

15. The non-transitory computer-readable storage medium of claim 10, wherein the contrastive loss is provided as part of a total loss further comprising a supervised loss, a masking loss, and an adaptation loss.

16. A system, comprising:
a computing device; and
a computer-readable storage device coupled to the computing device and having instructions stored thereon which, when executed by the computing device, cause the computing device to perform operations for provisioning machine learning (ML) models for visual inspection, the operations comprising:
providing a network backbone comprising a first ML model and a second ML model;
executing semi-supervised training of the network backbone using unlabeled training data, the semi-supervised training comprising two or more iterations comprising:
selecting a batch of unlabeled training data,
generating first predictions using the first ML model and second predictions using the second ML model,
determining a contrastive loss based on at least a portion of the first predictions and at least a portion of the second predictions, the contrastive loss being determined based on a global normalized confusion matrix (NCM) and a global cluster matrix (CM) maintained by an inter-class pixel affinity module (ICPAM) that is provided with the network backbone,
adjusting second parameters of the second ML model at least partially in response to the contrastive loss, and
adjusting first parameters of the first ML model using the second parameters of the second ML model; and
after completion of the semi-supervised training, deploying one of the first ML model and the second ML model for inference during production use.

17. The system of claim 16, wherein the first parameters of the first ML model are adjusted using an exponential moving average (EMA) on the second parameters of the second ML model.

18. The system of claim 16, wherein the global NCM is provided based on batch NCMs and the global CM is provided based on batch CMs across multiple iterations of the semi-supervised training.

19. The system of claim 16, wherein the contrastive loss is determined using class-bias weights that are determined using the global NCM.

20. The system of claim 16, wherein the contrastive loss is determined using a first sub-set of the first predictions as positive keys and a second sub-set of the first predictions as negative keys.
